(19) United States
(12) Patent Application Publication
(10) Pub. No.: US 2014/0184752 A1
(43) Pub. Date: Jul. 3, 2014

(54) METHOD OF CONTROLLING TWO CAMERAS OF A 3D CAMERA RIG AND CAMERA RIG

(71) Applicants: Christian Wieland, Augsburg (DE); Robert Siegl, Mering (DE); Martin Borchert, Kissing (DE); Matthias Lenz, Friedberg (DE)

(72) Inventors: Christian Wieland, Augsburg (DE); Robert Siegl, Mering (DE); Martin Borchert, Kissing (DE); Matthias Lenz, Friedberg (DE)

(21) Appl. No.: 14/009,794

(22) PCT Filed: Mar. 8, 2008
(86) PCT No.: PCT/EP12/01035

§ 371 Date: Mar. 11, 2014

(30) Foreign Application Priority Data
Apr. 5, 2011 (DE) 10-2011-016-169.4
Sep. 7, 2011 (DE) 10-2011-112726.0

(51) Int. Cl. H04N 13/02

(52) U.S. Cl. CPC H04N 13/0271; H04N 13/0239
USPC 348/47

(57) ABSTRACT

The invention relates to a method for controlling two cameras of a camera rig for shooting 3D films, wherein optimum values for the specific instant are used for a distance of the cameras from a point at which the optical axes of the cameras intersect, i.e. CVDₒₚₜ, and for a distance of the optical axes of the two cameras from each other in the area of the cameras, i.e. IAₒₚₜ. The invention further relates to a camera rig comprising two cameras for shooting a 3D film including a control for realizing such method.

### FIELD OF THE INVENTION

The invention relates to a method of controlling two cameras of a camera rig for shooting 3D films.

From the state of the art numerous camera rigs and methods of shooting and recording 2D films are known. For some time, however, more and more 3D films have been shot. 3D films are films that induce a three-dimensional effect with the viewer when they are presented on a screen, a display or any other player.

In order to induce a three-dimensional effect care has to be taken that the depth effect reached with the viewer is not too great and the viewed scene for the viewer does not raise the impression that it is located too far before or behind the screen or the display. Therefore it is known that maximum values of a background disparity and a foreground disparity must not be exceeded. A background disparity is understood to be the perspective displacement of a point on a display or a screen, the spot being located in the background of the scene. A foreground disparity is likewise referred to as a perspective displacement of a spot on the display or the screen, wherein the spot is located in the foreground of the scene.

Previously in the case of 3D camera rigs an operation by at least two persons has been necessary, because the one person has controlled both the focus and the zoom settings, whereas the other person has been in charge of the 3D effect. While the first person has been referred to as “focus puller”, the second person has been referred to as “stereo puller”. The “stereo puller” has controlled convergence and “inter-axial” values so far. By convergence the distance of the two cameras from a point is understood at which the two optical axes of the cameras intersect. Ultimately via the convergence the position of the scene is determined upon reproduction on a screen depending on the screen, i.e. further ahead of the screen, further behind the screen or around the screen.

The term “inter-axial” is understood to be a base distance which is the distance of the optical axes of the two cameras in the area of the two cameras.

It has turned out, however, that it is very difficult to adjust or at least control the 3D effect sufficiently well.

Therefore, it is the object of the present invention to provide an improved adjustment or at least an improved control with respect to the 3D effect. In particular the background disparity is to be prevented from becoming so high that for the viewer of the completed film unpleasant concomitants, such as headache due to the eyes “squinting outwardly”, are resulting.

This object is achieved in that optimum values calculated for the specific instant are used for a distance of the cameras from a point at which the optical axes of the cameras intersect, i.e. CVDₒₚₜ, and for a distance of the optical axes of the two cameras from each other in the area of the cameras, i.e. IAₒₚₜ.

In this way a particularly cost-efficient method can be achieved, as only one person is required for operating the camera. Said one person can operate the focus and the zoom, wherein the method according to the invention is implemented automatically, for example by adding an apparatus comprising a processor such as a computer.

Advantageous embodiments are claimed in the subclaims and will be explained hereinafter in detail.

It is of advantage when either of the two cameras is controlled so that the optical axis of the one camera moves relative to the optical axis of the other camera such that a point of convergence of the two optical axes moves backwards away from the cameras. In this way the point of convergence, which can also be referred to as intersection point, in the scene moves backwards away from the cameras, which is why the viewing angle is expanded. Thus the shown image is taken in such a changed condition that pleasant consequences induced in the viewer of the image again occur as quickly as possible and unpleasant concomitant phenomena are avoided, for example “squinting outwardly” is thus efficiently excluded.

In order to obtain a restoration of pleasant viewing as quickly as possible it is beneficial when one motor acting on a camera or two motors each acting on one camera are controlled for displacing the point of convergence backwards.

An improved condition can be reached especially quickly when the two cameras are simultaneously moved toward each other.

When both cameras are moved so that they adopt an optimized base distance value IAₒₚₜ calculated for this instant, an especially pleasant viewing result is achieved.

In order to be able to further optimize the viewing result it is of advantage to swivel the two cameras automatically away from each other about the one vertical axis extending through the respective camera, as soon as it is determined that at this instant a background disparity d_{min,real} of the recorded image infringes a limit value d_{min,critical}.

It is referred to infringement of the limit value d_{min,critical} when said limit value is exceeded in the direction of disparities higher according to amount located behind the point of convergence, which consequently corresponds to objects in the scene that are located behind the point of convergence. When, in the case of a lacking infringement of the limit value d_{min,critical} in the direction of disparities higher according to amount, the cameras are linearly moved toward each other or away from each other and/or the optical axes thereof are swiveled toward each other or away from each other so that the values CVDₒₚₜ and IAₒₚₜ are obtained, the desired pleasant viewing effect is reached especially quickly and the undesired concomitant phenomena are avoided for the viewer.

It is advantageous when the velocity of the two motors controlling and setting the convergence and the base distance is matched so that both motors simultaneously get to a standstill upon reaching the optimized conditions. The moving velocity relating to the base distance and relating to the convergence is adapted in this respect. This is due to the fact that a change of convergence can be obtained even with small incremental changes at the angles of the cameras, whereas larger distances have been covered by the cameras when the base distance is set. Also, when setting the base distance the entire camera or even both cameras have to be moved, which results in stronger motors due to the higher weight of the units to be adjusted.

Furthermore, it is of advantage when the background disparity is established in accordance with the formula

$${d}_{min , real} = \frac{b \cdot f ( C V D - {z}_{max} )}{C V D \cdot {z}_{max}}$$

wherein b is the base distance of the cameras, viz. the distance of the optical axes of the two cameras in the area of the two cameras, f is the focal length set, CVD is the convergence, viz. the distance of the cameras from a point at which the two optical axes of the cameras intersect, zₘₐₓ is the distance of the cameras from the rearmost element of the scene shot.

Another advantageous embodiment is characterized in that an optimum convergence value CVDₒₚₜ is calculated in accordance with the formula

$$C V {D}_{opt} = \frac{( {d}_{min} - {d}_{focal} ) {z}_{max} {z}_{focal}}{{d}_{min} {z}_{max} - {d}_{focal} {z}_{focal}}$$

wherein dₘᵢₙ is the desired background disparity, d_{focal} is the desired foreground disparity and Z_{focal} is the distance of the cameras from the foremost element of the scene shot, and that preferably an optimum base distance IAₒₚₜ is calculated in accordance with the formula

$${IA}_{opt} = \frac{{d}_{min} \cdot C V {D}_{opt} \cdot {z}_{max}}{f \cdot ( C V {D}_{opt} - {z}_{max} )} .$$

Unless the real values for the largest and smallest distances from the cameras contained in the scene are known, for the largest distance a value assumed to be constant can be utilized. For the smallest distance either the distance between the camera and the object which has been focused or another constant already determined in advance can be utilized. Furthermore, in a transition zone transitional values provided by a linear function mediating between the two values can be utilized.

It is especially beneficial in this context when a case-by-case analysis is made for Z_{focal}. When f is smaller than a threshold value W_{aSTOPP}, a constant value d_{aConstDist} is allocated to Z_{focal}. The threshold value W_{aSTOPP} is e.g. 12 mm in a camera having a focal length of from 6 to 300 mm.

When f is higher than a second threshold, i.e. w_{aSTART}, z_{focal} is equal to the actually existing focus distance which is the distance from the camera to the plane where objects are depicted in maximum sharpness. In the case of an afore-mentioned usual camera the threshold value could be approx. 50 mm. The first threshold value thus characterizes the transition from wide-angle, whereas the second threshold value represents the transition to the telephoto range. If the value is between the two threshold values 1 and 2, z_{focal} is calculated according to a linear transition function. The latter could be as follows

$${z}_{focal} = \frac{f - {w}_{aSTART}}{{w}_{aSTOPP} - {w}_{aSTART} ( {w}_{ConstDist} - focus ) + focus}$$

wherein “focus” is the distance of the camera from the focused point.

The invention also relates to a camera rig comprising two cameras for recording a 3D film having a control which realizes the method according to any one of the preceding claims.

The invention is also illustrated in detail with the aid of a drawing which shows in:

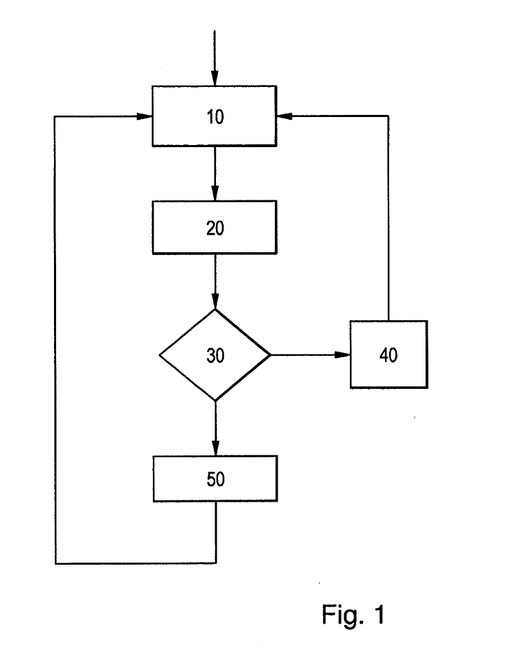

FIG. 1 a flow chart of an invention according to the method,

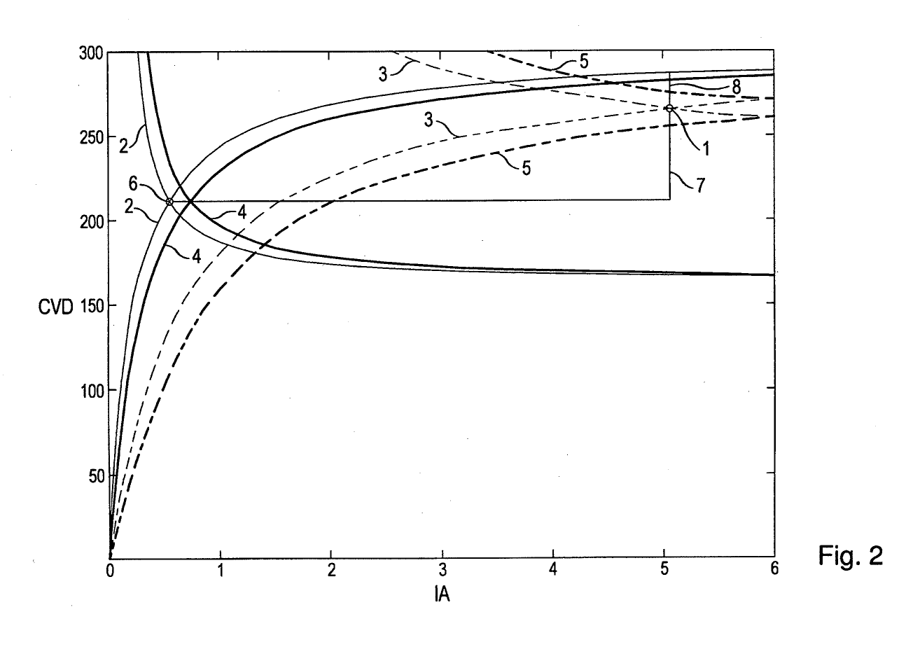

FIG. 2 a chart for illustrating the shift from a critical range in which high negative effects are provided when viewing a maximum depth of the scene into an optimum range and

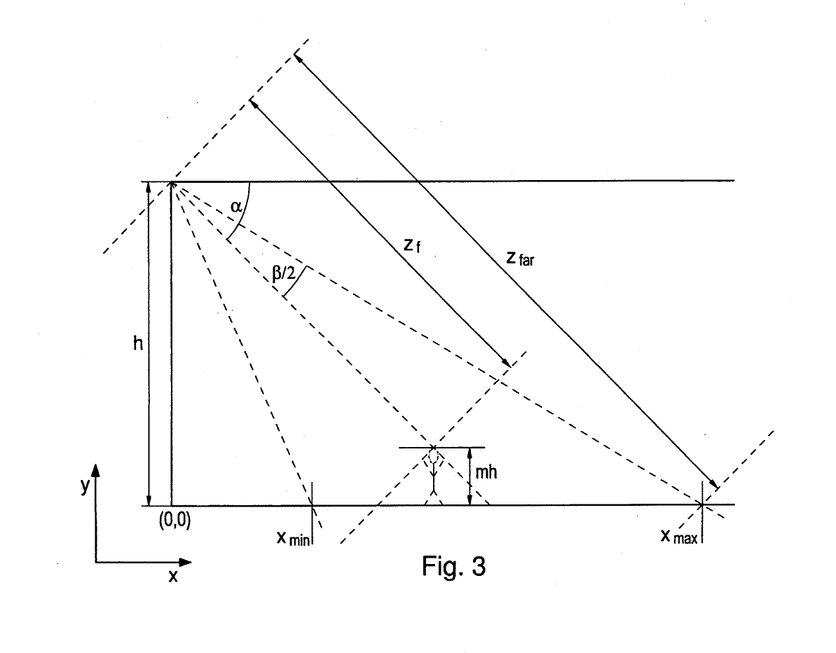

FIG. 3 a chart for showing the geometric relations in a camera rig positioned obliquely above a scene, such as on the stands of a sports stadium where a sports game is being shot.

The figures are merely of schematic nature and only serve for the comprehension of the invention.

In a first step 10 new optimum combinations of convergence and base distance are calculated in accordance with the following formulae.

These formulae are:

$$C V {D}_{opt} = \frac{( {d}_{min} - {d}_{focal} ) {z}_{max} {z}_{focal}}{{d}_{min} {z}_{max} - {d}_{focal} {z}_{focal}}$$

$$and$$

$${IA}_{opt} = \frac{{d}_{min} \cdot C V {D}_{opt} \cdot {z}_{max}}{f \cdot ( C V {D}_{opt} - {z}_{max} )}$$

In a subsequent step 20 a comparison with current positions is made.

After that, in a step 30 a case-by-case analysis is carried out in which it is found whether the background disparity is too high. In this context, the following formula is used

$${d}_{min , real} = \frac{b \cdot f ( C V D - {z}_{max} )}{C V D \cdot {z}_{max}} .$$

If the background disparity infringes the limit d_{min,critical}, step 40 is started next. In this case d_{min,critical} is a previously selected constant.

In step 40 the base distance is varied in the direction of an optimum value IAₒₚₜ and, contrary to expectations, the convergence CVD is enlarged. As soon as step 40 is completed, again step 10 is implemented.

Should the case-by-case analysis in step 30 anytime result in the fact that the limit value d_{min,critical} is no longer infringed by d_{min,real,} the values of the convergence and the base distance, i.e. CVD and IA, are both simultaneously varied in the direction of the respective optimum values CVDₒₚₜ and IAₒₚₜ. This is done in a step 50. After having implemented step 50, step 10 is implemented again.

In FIG. 2 on one axis the convergence, i.e. CVD, is inserted and on the abscissa the base distance IA is inserted. If the operator of the 3D camera changes the zoom and/or the focus, suddenly too high background disparity can happen to be present. Thus the point 1 is provided inside a space delimited by the lines 2. This is the space in which the undesired effects described in the beginning occur. Before the zoom and/or focus adjustment, on the contrary, the respective point was provided in the intersection of the previously relevant lines 3.

The lines 4 and 5 are shown offset by a safety offset, wherein the line 4 is the safety offset of the line 2 and the line 5 is displaced from the line 3 without any safety offset.

Although the quickest possible shift of point 1 from the critical area to a new optimum point 6 along the shifting line 7 would be possible, in that case an undesired disadvantageous perception by the viewer would be stated for the entire duration of shifting.

Therefore it is necessary to get out of the critical area as quickly as possible, which is why the alternative path 8 is taken. On this path the point very quickly moves immediately out of the critical area and exceeds the upper line 4, i.e. the line shifted with a safety distance. Then it is provided on the line 2 and is shifted along this line to the optimum value 6 when the motors are appropriately controlled.

The afore-described method calculates an optimum combination of eye distance (inter-axial, base distance) and convergence distance for a stereo camera system. For this purpose, it takes several pieces of information known via the stereo camera system such as focal length, sharpness distance, size of image sensor, current eye distance, current convergence distance into consideration as well as setting parameters describing the desired depth effect, for example background and foreground disparity dₘᵢₙ, dₘₐₓ, d_{min,critical}, d_{max,critical}). Moreover an optimum movement profile is calculated for the transition from the current position to the new position.

The extension described hereinafter further includes depth information obtained from the stereoscopic pair of images with the aid of image processing into the calculation. It is the paramount feature of this implementation that no complete depth analysis is required. In the simplest case only the central horizontal shift, also referred to as d_{avg,img}, between the left and the right partial image is calculated and used for refining the control. Such mean value can be determined with very little latency or time delay and therefore is well suited for building up a control loop.

Different forms make additional use of the largest and smallest shifts d_{max,img} and d_{min,img}, respectively, or a depth histogram, i.e. the frequency distribution of the shifts between the left-hand and right-hand partial images.

Making use of this extra information can be useful when model assumptions made for the method are not or only partly valid. Examples hereof are deviations of the camera lens calibrating data from the actual characteristics of the paired objective used, operating errors of the cameraman during focusing or deviations of the information generated by the 3D camera rig about convergence distance and eye distance from reality.

By way of the information obtained from the image analysis, in this way a short-term cursory correction term can be calculated for compensating these deviations and harmonizing the depth distribution actually existing in the paired image with the depth distribution specified for the desired depth effect.

The concretely implemented method is based on the assumption that the average shift between the left-hand and right-hand partial images corresponds approximately to the mean value between the foreground and background disparities.

The following method is used as supplement to each cycle of the original control loop:
1. First the mean value of the values assumed according to the original method as current foreground and background disparities (d_{min,real}, d_{max,real}) is calculated (d_{avg,modell}).
2. This value is compared to the value (d_{avg,img}) from image processing.
3. If the amount of the difference exceeds a previously fixed threshold diffₘₐₓ, a correction value δ is increased or reduced so that the sum d_{avg,modell}+δ approximates the value d_{avg,img}.
4. This improved model then can be further used in the manner described in the original patent.

In an advantageous embodiment it is in fact not the model for the current disparities which is changed, but the target values are changed by an appropriate amount. In the implementation this may be simpler than the original implementation, but it provides the same results as the original version, because the underlying control deviation is the same.

In addition, optionally the deviation δ can be newly calculated with each cycle or can merely be updated for each cycle.

In the case of image processing which does not only provide the mean value but both minimum disparity and maximum disparity, the method can be carried out, as afore-described for the mean value, separately both for the maximum value and for the minimum value.

When, as is common in a lot of sports, the camera looks down from a large height, for example from the stands of a sports stadium, to a setting substantially taking place on a horizontal plane such as the field, then one of the basic assumptions of the algorithm from the original patent, i.e. that the background distance z_{far} is constant, is no longer applicable. This becomes clear from a synopsis with FIG. 3.

The described extension of the method improves the results in this scenario. In particular in the case of great focal lengths, when the camera only perceives a small cut-out of the field, the distance of the most remote visible point is strongly dependent on the angle of inclination α, ergo “tilt”, of the camera.

If, in addition, the height h of the camera relative to the field and the aperture angle β of the camera are known, the distance z_{far} can be calculated in accordance with the equations stated hereinafter.

The aperture angle of a camera can be easily calculated from the size of the image sensor and the focal length, as is known.

If the stereo camera system includes a tilt sensor, for example in a first embodiment, the tilt angle a can be easily determined. This tilt sensor can be accommodated in the stereo rig itself or else in the tripod head.

Unless the stereo camera system includes a tilt sensor, for example in a second embodiment, the tilt angle α can be determined by approximation. It is assumed that in most cases the camera is focused on an object just above the field plane. The focus distance is z_{f}. The height mh of this object can be assumed in good approximation as a constant of 180 cm, approximately the size of a human being. Thus the following is resulting

$$α = a sin ( \frac{h - mh}{{z}_{f}} ) ;$$

$${x}_{min} = h \cdot cotan ( α + \frac{β}{2} ) ;$$

$${x}_{max} = h \cdot cotan ( α - \frac{β}{2} )$$

With the aid of the estimated or measured tilt angle then z_{far} can be calculated:

$${z}_{far} = \frac{h}{sin ( α - \frac{β}{2} )} .$$

An approach based on heuristics can be supplemented by the use of image processing data or can be replaced by the same. Both aspects thus can be realized in combination or individually. LIST OF REFERENCE NUMERALS

1 point

2 line

3 line

4 line

5 line

6 optimum value

7 displacement path

8 alternative path

1. A method of controlling two cameras of a camera rig for shooting 3D films, wherein optimum values calculated for a specific instant are used for a distance of the cameras from a point at which the optical axes of the cameras intersect, i.e. CVDₒₚₜ, and for a distance of the optical axes of the two cameras from each other in the area of the cameras, i.e. IAₒₚₜ.

2. The method according to claim 1, wherein the two cameras are automatically swiveled away from each other about the one vertical axis extending through the respective camera as soon as it is determined that a background disparity d_{min,real} of the recorded image at such instant exceeds or falls below a limit value d_{min,critical}.

3. The method according to claim 1 or 2, characterized in that at least either of the two cameras is controlled so that the optical axis of the one camera moves relative to the optical axis of the other camera such that a convergence point or intersection of the two optical axes moves backwards away from the cameras.

4. The method according to claim 3, characterized in that a motor acting on a camera or two motors each acting on a camera are controlled for displacing the convergence point backwards.

5. The method according to any one of the claims 1 to 4, characterized in that the two cameras are simultaneously moved toward each other or away from each other.

6. The method according to claim 5, characterized in that both cameras are moved so that they adopt an optimized base distance value IAₒₚₜ calculated for such instant.

7. The method according to claim 6, characterized in that in the case of a lack of exceeding or falling below the limit value d_{min,critical,} the cameras are linearly moved toward each other and/or the optical axes thereof are swiveled toward each other so that the values CVDₒₚₜ and IAₒₚₜ are obtained.

8. The method according to any one of the claims 1 to 7, characterized in that the background disparity d_{min,real} is established according to the formula
$${d}_{min , real} = \frac{b \cdot f ( C V D - {z}_{max} )}{C V D \cdot {z}_{max}}$$
wherein b is the base distance of the cameras, i.e. the distance of the optical axes with two cameras in the area of the two cameras, f is the focal length set, CVD is the convergence, i.e. the distance of the cameras from a point at which the two optical axes of the cameras intersect, Zₘₐₓ is the distance of the cameras from the rearmost element of the shot scene.

9. The method according to any one of the claims 5 to 8, characterized in that an optimum convergence value CVDₒₚₜ is calculated according to the formula
$$C V {D}_{opt} = \frac{( {d}_{min} - {d}_{focal} ) {z}_{max} {z}_{focal}}{{d}_{min} {z}_{max} - {d}_{focal} {z}_{focal}}$$
wherein dₘᵢₙ is the background disparity, d_{focal} is the foreground disparity and Z_{focal} is the distance of the cameras from the foremost element of the shot scene and that preferably an optimum base distance value IAₒₚₜ is calculated in accordance with the formula
$${IA}_{opt} == \frac{{d}_{min} \cdot C V {D}_{opt} \cdot {z}_{max} \cdot 12}{f \cdot ( C V {D}_{opt} - {z}_{max} )} .$$

10. A camera rig comprising two cameras for shooting a 3D film including a control for realizing the method according to any one of the preceding claims.
